(19) United States
(12) Patent Application Publication
(10) Pub. No.: US 2008/0019420 A1
(43) Pub. Date: Jan. 24, 2008

(54) Exchange of detection and avoidance information

(75) Inventors: Nicholas Michael Carbone, San Diego, CA (US); Timothy Leo Gallagher, Encinitas, CA (US); Nishant Kumar, San Diego, CA (US); Siddharth Shetty, San Diego, CA (US); James Laurence Taylor, Sherborne (GB)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/726,737

(22) Filed: Mar. 21, 2007

Related U.S. Application Data
(60) Provisional application No. 60/784,204, filed on Mar. 21, 2006.
(60) Provisional application No. 60/791,657, filed on Apr. 12, 2006.

(51) Int. Cl. H04B 1/00; H04Q 7/24

(52) U.S. Cl. 375/132; 370/338

(57) ABSTRACT

A protected wireless device is avoided. An indication is received that another wireless device has detected a protected wireless device. The protected wireless device is avoided in the event the wireless device that detected the protected wireless device is within a threshold number of hops from the wireless device that received the indication.

### CROSS REFERENCE TO OTHER APPLICATIONS

This application claims priority to U.S. Provisional Patent Application No. 60/784,204 (Attorney Docket No. AIELP065+) entitled INTERFERENCE DETECTION AND PROPAGATION WITHIN A BEACON GROUP filed Mar. 21, 2006 which is incorporated herein by reference for all purposes, and priority to U.S. Provisional Patent Application No. 60/791,657 (Attorney Docket No. AIELP067+) entitled INFORMATION EXCHANGE AND COEXISTENCE ASSOCIATED WITH COLLOCATED WIRELESS DEVICES filed Apr. 12, 2006 which is incorporated herein by reference for all purposes.

### BACKGROUND OF THE INVENTION

Currently, some regulatory agencies are developing rules regarding the interoperation of wireless devices. Often, these rules are intended to protect wireless devices that operate in a licensed frequency spectrum from other wireless devices. For example, some rules seek to protect WiMAX devices (which operate in a licensed frequency spectrum) from ultra wideband (UWB) wireless devices (which operate over a relatively large frequency spectrum, such as 528 MHz or more). In some cases, a protected wireless device and an interfering wireless device are separate systems. In other cases, a protected wireless device and an interfering wireless device are included in the same system (i.e., they are collocated). It would be desirable to develop new techniques associated with detection and/or avoidance that, for example, offer a balance between protection of a protected wireless device and throughput of the interfering wireless device and/or can be used with collocated devices.

### BRIEF DESCRIPTION OF THE DRAWINGS

Various embodiments of the invention are disclosed in the following detailed description and the accompanying drawings.

FIG. 1 is a diagram illustrating an embodiment of a group of wireless devices configured to avoid a protected wireless device.

FIG. 2 is a diagram illustrating an embodiment of superframes.

FIG. 3 is a flowchart illustrating an embodiment of a process for generating and transmitting a beacon that includes detection and/or avoidance information.

FIG. 4 is a diagram illustrating an embodiment of a beacon with information elements used to exchange detection and/or avoidance information.

FIG. 5 is a diagram illustrating an embodiment of a time frequency interleaving (TFI) channel.

FIG. 6 is a diagram illustrating an embodiment of subcarriers in bands that are avoided.

FIG. 7 is a diagram illustrating an embodiment of avoided subcarriers and/or bands described using run length encoding.

FIG. 8 is a block diagram illustrating an embodiment of a system with collocated wireless devices.

FIG. 9 is a diagram illustrating an embodiment of a mobile telephone and some devices it communicates with.

FIG. 10 is a flowchart illustrating an embodiment of a process for obtaining information specified by a regulatory agency.

FIG. 11 is a flowchart illustrating an embodiment of a process for avoiding a paging time of a mobile telephone.

FIG. 12 is a flowchart illustrating an embodiment of a process for adjusting UWB properties based on RSSI information.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, a protected wireless device and an interfering wireless device are separate systems. The following figures illustrate some such embodiments.

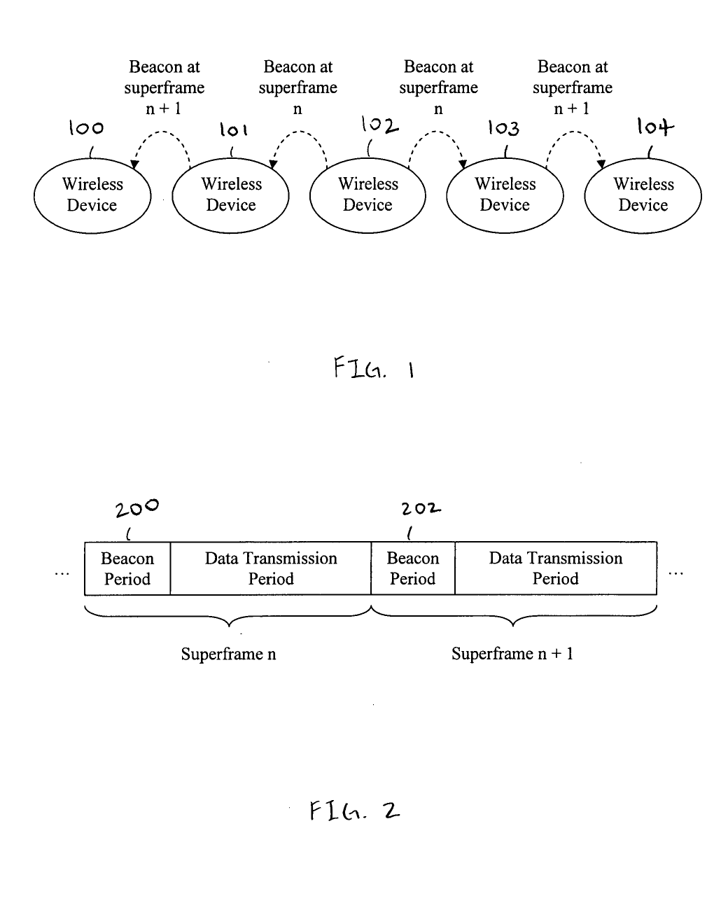

FIG. 1 is a diagram illustrating an embodiment of a group of wireless devices configured to avoid a protected wireless device. In the example shown, the wireless devices are arranged along a line. As a result of this topography, each wireless device in the group can only hear (i.e., properly receive and process information from) its immediate neighbor(s). For example, wireless device 100 is only able to hear wireless device 101, wireless device 101 is only able to hear wireless devices 100 and 102, wireless device 102 is only able to hear wireless devices 101 and 103, wireless device 103 is only able to hear wireless devices 102 and 104, and wireless device 104 is only able to hear wireless device 103. In other embodiments, there is some other topography than the example shown herein.

In this example, wireless devices 100-104 are configured to detect and avoid other, protected wireless devices. In some embodiments, wireless devices 100-104 are ultra wideband (UWB) devices (e.g., WiMedia UWB devices) and are configured to avoid narrowband wireless devices, such as WiMAX (i.e., IEEE 802.16) devices, and/or wireless devices that operate in a licensed frequency spectrum. In some embodiments, wireless devices 100-104 and/or a protected wireless device is associated with some other wireless protocol or specification besides the examples above.

In various embodiments, various detection and avoidance techniques are used. For example, in some embodiments, a given wireless device analyzes or otherwise processes a received signal to determine if a protected wireless device is located nearby. In some embodiments, to avoid another wireless device, certain frequency ranges are not transmitted in or otherwise used by a wireless device. An avoided frequency range may be described by band(s) and/or subcarrier(s).

In the example shown, wireless device 102 detects a protected wireless device and is the only device in the group to do so (e.g., because the protected wireless device is located relatively close to wireless device 102). As a result of the detection, wireless device 102 decides to avoid certain frequencies. To signal it has detected a protected wireless device and indicate the bands and/or subcarriers being avoided as a result, wireless device 102 transmits a beacon during the nth superframe with this information. This beacon is received by wireless devices 101 and 103. In some embodiments, beacons are broadcast and wireless devices 101 and 103 receive the same beacon. In some cases, beacons in addition to those shown are transmitted. For example, in some embodiments, each wireless device transmits a beacon at each superframe. For clarity, other beacons are not shown in this figure.

Upon receiving that beacon from wireless device 102, wireless devices 101 and 103 decide to avoid the same bands and/or subcarriers avoided by wireless device 102. In some embodiments, wireless devices 101 and 103 avoid different bands and/or subcarriers as wireless device 102.

In various embodiments, wireless devices 101 and 103 begin avoiding those bands and/or subcarriers at various times. In some embodiments, wireless devices 101 and 103 immediately begin avoiding frequencies as soon as the beacon transmitted by wireless device 102 in the nth superframe is received and processed. In some embodiments, it is undesirable to immediately avoid a band and/or subcarrier (e.g., without warning another wireless device) and a band and/or subcarrier is used until a “graceful” transition to can occur.

At the next superframe (i.e., n+1), wireless devices 101 and 103 each transmit a beacon. In their respective beacons, wireless devices 101 and 103 in this example each indicate that they are avoiding certain bands and/or subcarriers but that they did not detect a protected wireless device.

Receivers in this example are thus able to know the bands and/or subcarriers being avoided by wireless devices 101 and 103 upon receiving their beacons and also know that wireless devices 101 and 103 did not actually detect a protected wireless device. Receivers of a beacon from wireless device 102 would know its avoided bands and/or subcarriers, and would also know that wireless device 102 detected a protected wireless device.

In this example, only wireless devices that are 1-hop away from a detecting wireless device (e.g., wireless device 102) also have to avoid a protected wireless device. For example, wireless device 100 receives the beacon transmitted by wireless device 101 and wireless device 104 receives the beacon transmitted by wireless devices 103 in superframe n+1. Wireless devices 100 and 104 may use information included in the beacons to perform processing on a received signal (e.g., wireless devices 100 and 104 may discard data received in avoided bands and/or subcarriers) but in this embodiment do not avoid a protected wireless device. In some embodiments, some other distance is used besides a 1-hop distance. For example, in some embodiments, wireless devices within a 2-hop distance must avoid certain bands and/or subcarriers.

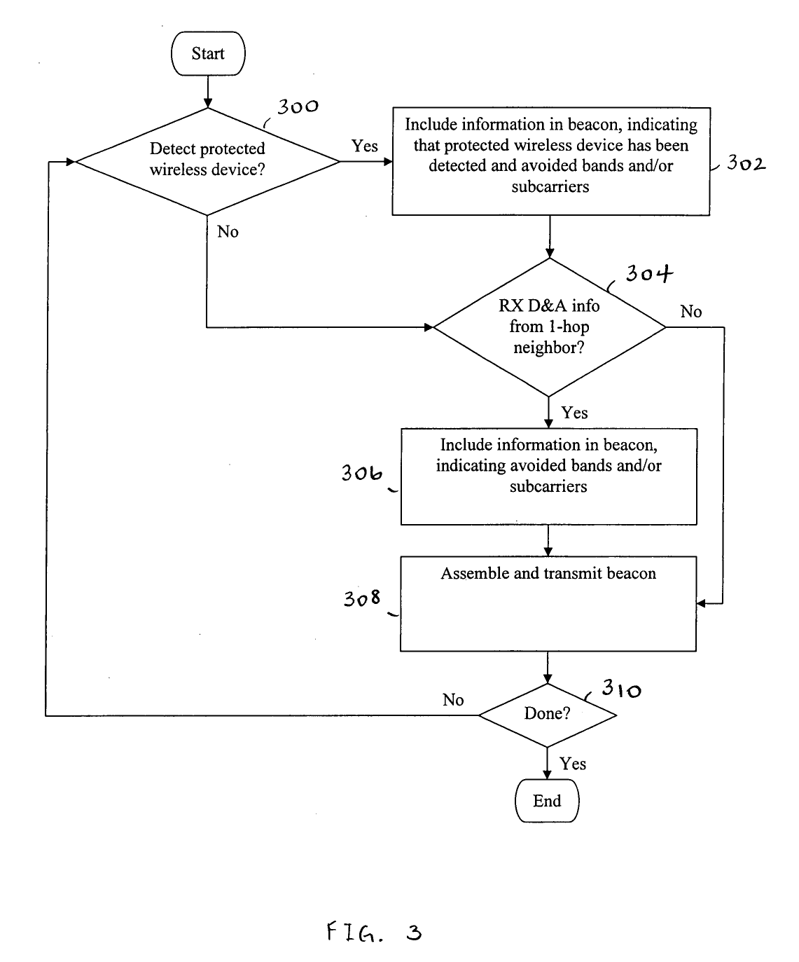

FIG. 2 is a diagram illustrating an embodiment of superframes. In some embodiments, the beacons transmitting in FIG. 1 are transmitting during the superframes shown. In this example, each superframe comprises of a beacon period (used to exchange beacons) followed by a data transmission period (used to transmit data); each period includes any number of slots.

In this example, the beacon transmitted by wireless device 102 is transmitted during beacons period 200 of superframe n. The beacons transmitted by wireless devices 101 and 103 are transmitted in beacon period 202 of superframe n+1. In some embodiments, each wireless device transmits its respective beacon at the same slot at each beacon period. For example, wireless device 100 may always transmit its beacon during slot x of the beacon period, wireless device 101 may transmit its beacon during slot y, etc.

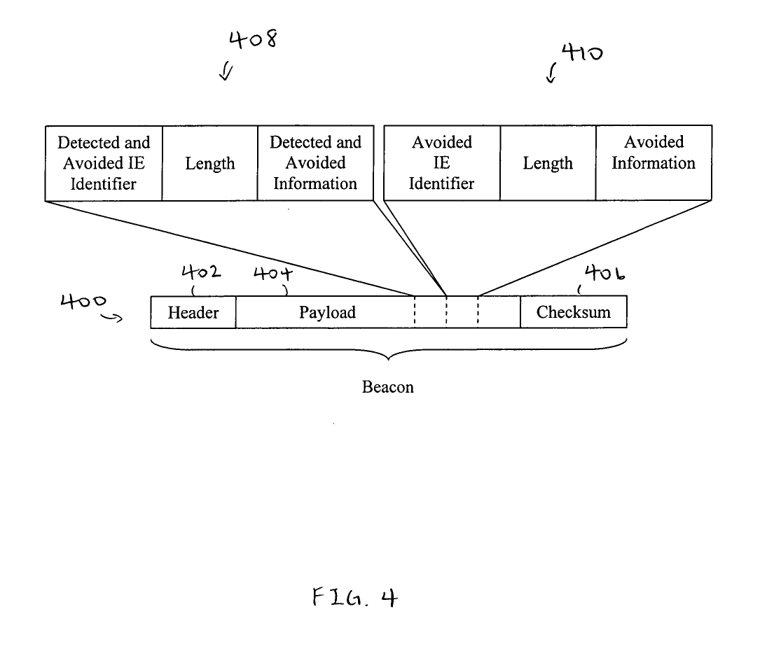

FIG. 3 is a flowchart illustrating an embodiment of a process for generating and transmitting a beacon that includes detection and/or avoidance information. In some embodiments, the example process is performed by a wireless device shown in FIG. 1. In some embodiments, some other process is used to generate and transmit a beacon.

At 300, it is determined whether a protected wireless device is detected. Any appropriate detection technique may be used, such as by including a receiver configured to operate according to the protected wireless device, or by measuring energy levels at certain frequencies. If a protected wireless device is detected, information is included in a beacon, indicating that a protected wireless device has been detected and avoided bands and/or subcarriers at 302. For example, if the example process is performed by the wireless devices of FIG. 1, wireless device 102 would perform this step but wireless devices 101 and 103 would not perform this step.

After including the information at 302 or if no protected wireless device is detected, it is determined at 304 if detection and/or avoidance information is received from a 1-hop neighbor. For example, if wireless device 101 is performing the example process, this decision at 304 would be “Yes” after receiving the beacon from wireless device 102 at the nth superframe.

If such information is received, information is included in a beacon, indicating avoided bands and/or subcarriers at 306. In some embodiments, the information included at 302 is encoded or described differently than the information included at 306, such as by using different information elements. In some embodiments, this enables a wireless device that receives a beacon to know which bands and/or subcarriers are being avoided because the transmitting wireless device actually detected a protected wireless device, as opposed to because a (e.g., 1-hop) neighbor detected a protected wireless device.

After including information at 306 or if no information is received at 304, a beacon is transmitted and assembled at 308. It is determined at 310 if a process is done. If not, at 300 it is determined if a new protected wireless device is detected.

In some embodiments, information included at 302 and 306 are included in different information elements in the payload of a beacon. The following figure illustrates one such embodiment.

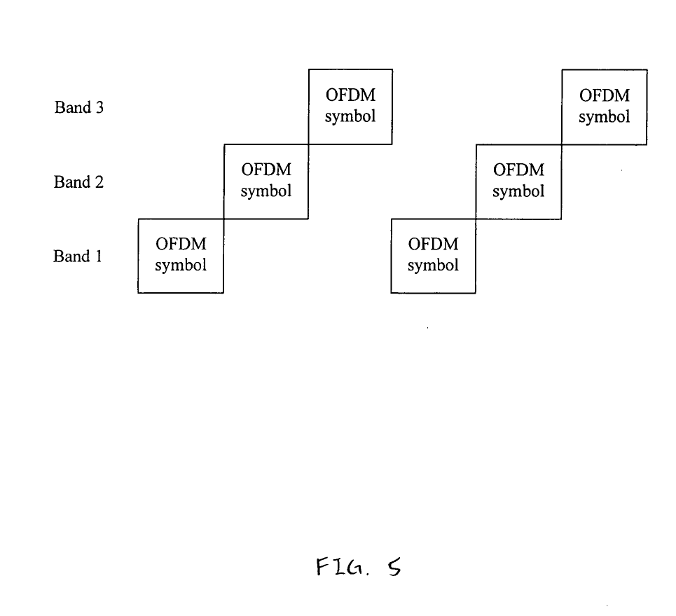

FIG. 4 is a diagram illustrating an embodiment of a beacon with information elements used to exchange detection and/or avoidance information. In some embodiments, beacon 400 is generated using the process of FIG. 3. In the example shown, beacon 400 includes header 402, payload 404, and checksum 406. Payload 404 in this example includes information elements 408 and 410; in some embodiments, payload 404 includes information elements in addition to information elements 408 and 410.

In some embodiments, information element 408 is included in beacon 400 if step 302 is performed. In some embodiments, information element 410 is included in beacon 400 if step 306 is performed. Various beacons will therefore include neither, one, or both of information elements 408 and 410. Each of information elements 408 and 410 includes an identifier, length, and associated information. In some embodiments, the identifiers are unique identifiers that allow information elements 408 and 410 to be distinguished from each other, as well as other information elements. The length fields describe how long each information element is (e.g., in units of bytes).

In some embodiments, frequencies that are avoided (e.g., described by band and/or subcarrier) are included in either information element 408 or 410, but not both. For example, inclusion in information element 408 in some embodiments indicates that the wireless device that transmitted the beacon has detected a protected wireless device and is avoiding the indicated frequencies. Otherwise, if included in information element 410, the transmitting wireless device has not actually detected the protected wireless device but, for example, is a 1-hop neighbor of a wireless device that did detect a protected wireless device.

In various embodiments, information included in information elements 408 and/or 410 are encoded or described in a variety of ways. The following figures describe an embodiment in which information is run length encoded. In some embodiments, some other encoding technique is used.

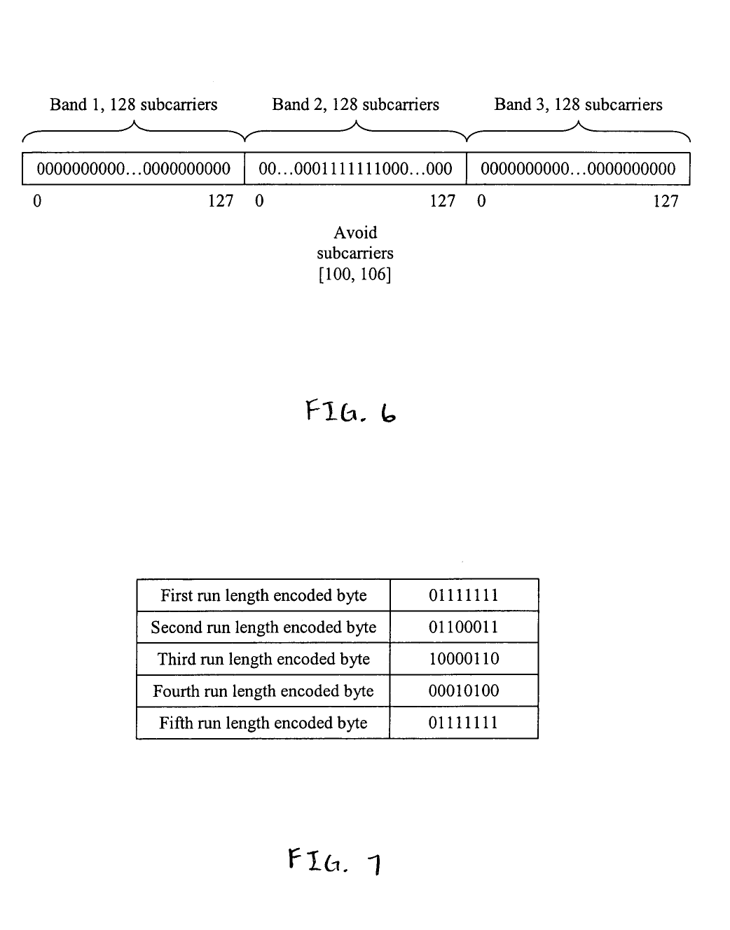

FIG. 5 is a diagram illustrating an embodiment of a time frequency interleaving (TFI) channel. In the example shown, the wireless devices are WiMedia UWB devices. Packets or frames are made up of Orthogonal Frequency-Division Multiplexing (OFDM) symbols and are transmitted on a wireless channel. In WiMedia UWB, there are two types of wireless channels: time frequency interleaving (TFI) and fixed frequency interleaving (FFI). TFI channels use a plurality of bands that are repeated; FFI channels use a single band. In this example, a TFI channel is shown with a hop pattern of band 1, band 2, and band 3. In some embodiments, some other channel is used besides the example shown herein.

FIG. 6 is a diagram illustrating an embodiment of subcarriers in bands that are avoided. In the example shown, a wireless device is using the TFI channel shown in FIG. 5. In this particular example, subcarriers 100 thru 106 (inclusive) in band 2 are avoided. In some embodiments, the wireless device avoiding these subcarriers in band 2 detected a protected wireless device; in some embodiments, the wireless device avoiding the example subcarriers is, for example, 1-hop away from a detecting wireless device. In this example, a 0 indicates that the corresponding subcarrier is being used and a 1 indicates that it is being avoided. In some embodiments, the polarity is reversed.

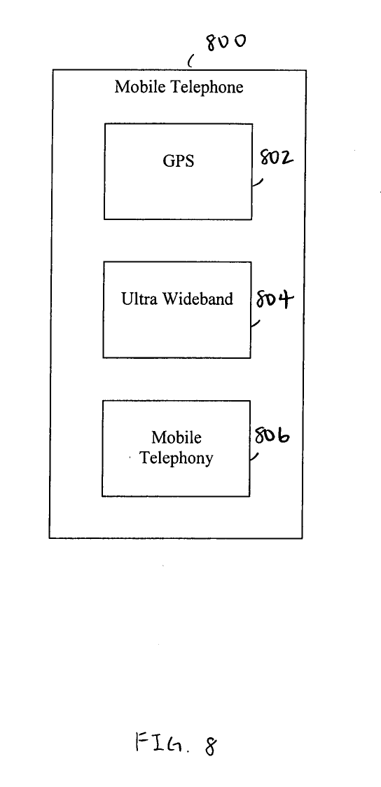

FIG. 7 is a diagram illustrating an embodiment of avoided subcarriers and/or bands described using run length encoding. In the example shown, the avoided subcarriers and bands shown in FIG. 6 are run length encoded. In some embodiments, some other type of run length encoding is used. In some embodiments, a FFI channel is used and avoided subcarriers in an FFI channel are run length encoded.

In this example, the most significant bit (MSB) of each byte is used to indicate what symbol is being repeated (e.g., a 0 or a 1) and the remaining bits are equal to one less than the number of times that symbol is repeated. The first byte (01111111) indicates that a 0 is repeated 128 times; this corresponds to using all 128 subcarriers in band 1. The second byte (01100011) indicates that a 0 is repeated 100 times, corresponding to subcarriers [0, 99] in band 2. The third byte (10000110) indicates that a 1 is repeated 7 times, corresponding to subcarriers [100, 106] in band 2; those subcarriers are avoided. The fourth byte (00010100) indicates that a 0 is repeated 21 times, corresponding to subcarriers [107, 127] in band 2. The fifth byte (01111111) indicates that a 0 is repeated 128 times; this corresponds to using all 128 subcarriers in band 3.

In some cases, using run length encoding is attractive because fewer bytes (or other units) are used compared to some other techniques. For example, if the information shown in FIG. 6 is straightforwardly transformed into bytes, a total of 48 bytes would be required (e.g., first byte corresponds to subcarriers [0, 7] of band 1, second byte corresponds to subcarriers [8, 15] of band 1, etc.) instead of 5 bytes. Reducing the number of bytes needed may correspond to less overhead information being exchanged and greater efficiency. This may permit detection and/or avoidance information to be exchanged more often (e.g., every beacon) and/or at less cost each time such information is exchanged.

In some embodiments, run length encoded information is included in an information element in a beacon. In some embodiments, run length encoded information is used at an interface between a media access controller (MAC) and a baseband processor (i.e., PHY) configured to perform physical layer processing (e.g., interleaving, modulation, and/or encoding). For example, a MAC may communicate to a baseband processor which subcarriers in which bands to avoid using one or more registers. Run length encoded information in some embodiments is written to such registers. This is attractive in some applications since fewer registers and/or fewer writes to such registers are used.

In some embodiments, a protected device is collocated with an interfering device. The following figures show some embodiments of collocated devices and some examples of information that is exchanged.

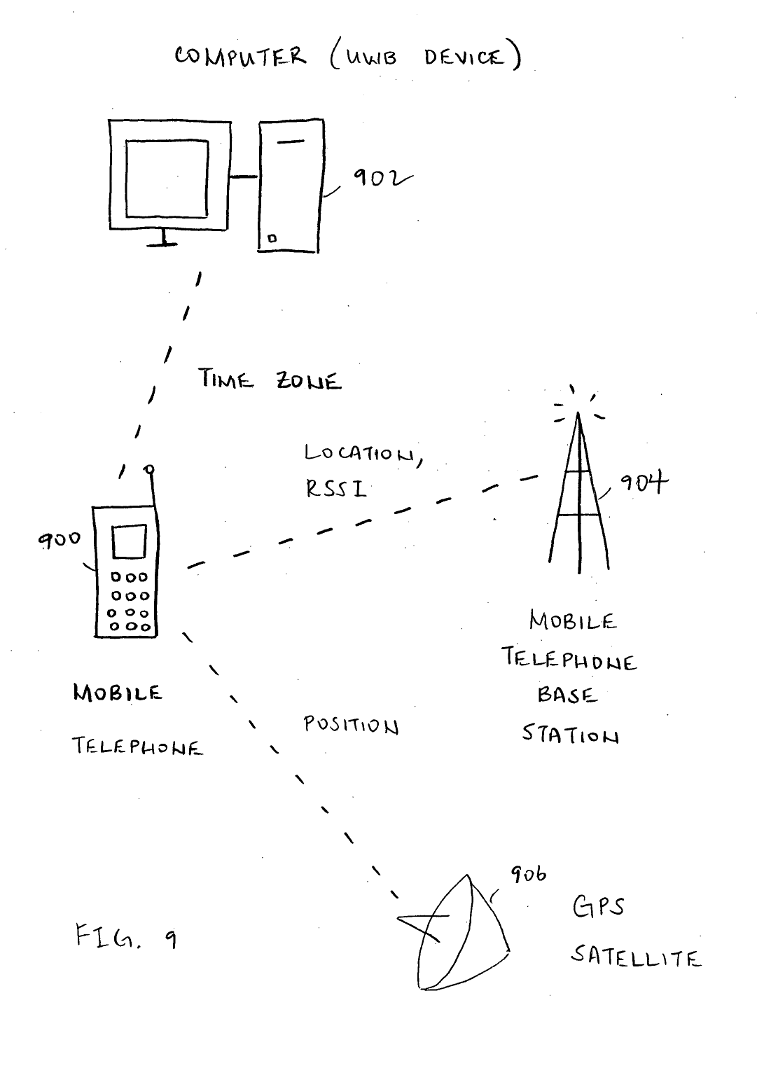

FIG. 8 is a block diagram illustrating an embodiment of a system with collocated wireless devices. As used herein, collocated devices are devices that are included in the same system. In the example shown, a variety of wireless components are included in mobile telephone 800. Each wireless component in this example includes its own transceiver for communication on its respective channel. In various embodiments, various pieces of information are exchanged between wireless components included in mobile telephone 800.

In some embodiments, Global Positioning System (GPS) 802 communicates with a GPS satellite to obtain coordinates or other position related information. In some embodiments, position information is passed from GPS 802 to another component. For example, during a 911 call, positioning information may be passed from GPS 802 to mobile telephony 806. Mobile telephone 806 may relay the positioning information to a dispatcher at a 911 call center via mobile telephone infrastructure.

Mobile telephony 806 in this example is associated with communication over a mobile telephone network. Component 806 may support a variety of digital or analog mobile telephone protocols including Code Division Multiple Access (CDMA), Personal Communications Services (PCS), and Global System for Mobile Communications (GSM). In some embodiments, other data may be exchanged using mobile telephony 806 in addition to voice related data. For example, mobile telephone 806 may support text messaging services such as Short Message Service (SMS).

UWB 804 may be used to exchange data over a broadband wireless network. In this embodiment, UWB 804 is a WiMedia UWB component. In various embodiments, UWB 804 obtains a variety of information from GPS 802 and/or mobile telephony 806 and uses this information to, for example, adjust its transmissions. For example, in some embodiments, UWB 804 reduces a transmit power level or does not transmit during an important time or communication for a collocated wireless device.

In some embodiments, a common clock source is supplied to UWB component 804 and a collocated Bluetooth component (not shown). A common clock source may enable collocated components to have a timing reference that has little or no offset between the two components. In some embodiments, a UWB component tracks a Bluetooth period and does not transmit during certain portions of the Bluetooth period. For example, there may be certain management or control frames which are important for the Bluetooth component to receive. In such embodiments, the UWB component may track the Bluetooth period and does not transmit during a time corresponding to transmission of the management or control frames. In some embodiments, UWB 804 obtains or extracts GPS timing information from GPS 802. In some embodiments, UWB 804 transmits timing information on a UWB channel to another UWB device. This transmitted information may be received by a nearby UWB device (perhaps without a collocated GPS component) that is capable of interfering with components of mobile telephone 800. For example, a UWB component in a digital camera may receive timing information from mobile telephone 800 and use the timing information to coexist with components of mobile telephone 800.

In some embodiments, a system that includes collocated wireless components is a system other than a mobile phone. For example, personal digital assistants and laptop computers may have collocated wireless components. In some embodiments, a system includes a different set of collocated wireless components. For example, a Bluetooth component or an IEEEE 802.11 a/b/g (WiFi) component may be included in addition to or as an alternative to a component shown in the example of FIG. 8.

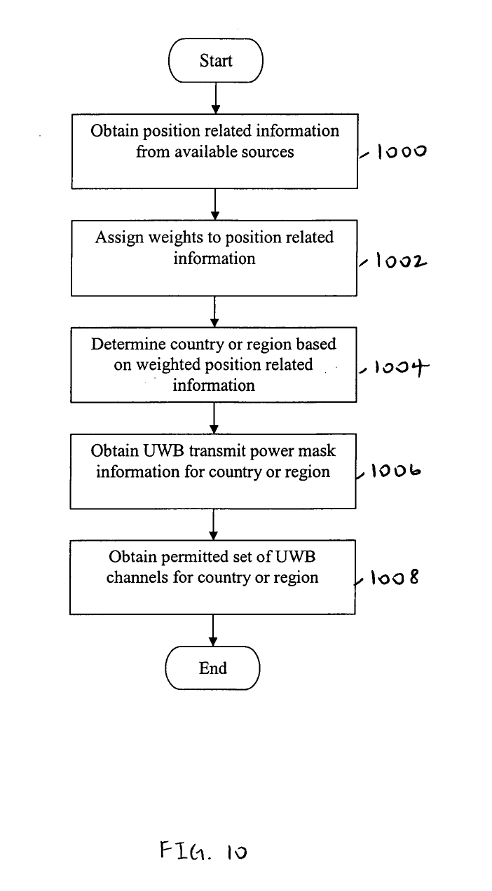

FIG. 9 is a diagram illustrating an embodiment of a mobile telephone and some devices it communicates with. In the example shown, mobile telephone 900 includes collocated GPS, UWB, and mobile telephony components. Each component includes a transceiver configured to transmit and receive according its respective protocol.

In some embodiments, using a UWB component included in mobile telephone 900, time zone information is obtained from computer 902. Computer 902 may have a removable UWB transceiver, (e.g., inserted into a slot of computer 902) or may have a built-in UWB component. A user may specify time zone information via a calendar or clock feature operating on computer 902. In some embodiments, a smaller region or country within a time zone is specified by a user and obtained from computer 902. For example, South Korea and Japan are in the same time zone but a user may be able to specify Japan as his location. In some embodiments, a specified country or other time zone information is obtained from computer 902.

Some mobile telephony components that may be included in mobile telephone 900 determine a Received Signal Strength Indication (RSSI) based a signal received from mobile telephone base station 904, hereafter referred to as a base station. In some cases, RSSI is a gross measurement of received power with respect to a band used by a mobile telephony component in mobile telephone 900. RSSI can be implementation dependent and vary from mobile telephone to mobile telephone. In some mobile telephone systems, location information is provided by base station 904. For example, in order to support 911 capabilities, base station 904 may identify a neighborhood or area in which base station 904 provides service. As shown in this example, in some embodiments, mobile telephone 900 obtains location and/or RSSI information from base station 904.

A GPS component in mobile telephone 900 communicates with GPS satellite 906 to obtain position information. Position information may include latitude, longitude, and/or elevation information. In some embodiments, a time is calculated by the GPS component. A time calculated by a GPS component matches to a relatively precise degree the times calculated by other GPS devices independent of location.

A UWB component in mobile telephone 900 uses some or all of this information to coexist with collocated wireless components. In a variety of embodiments, different information is obtained from different sources.

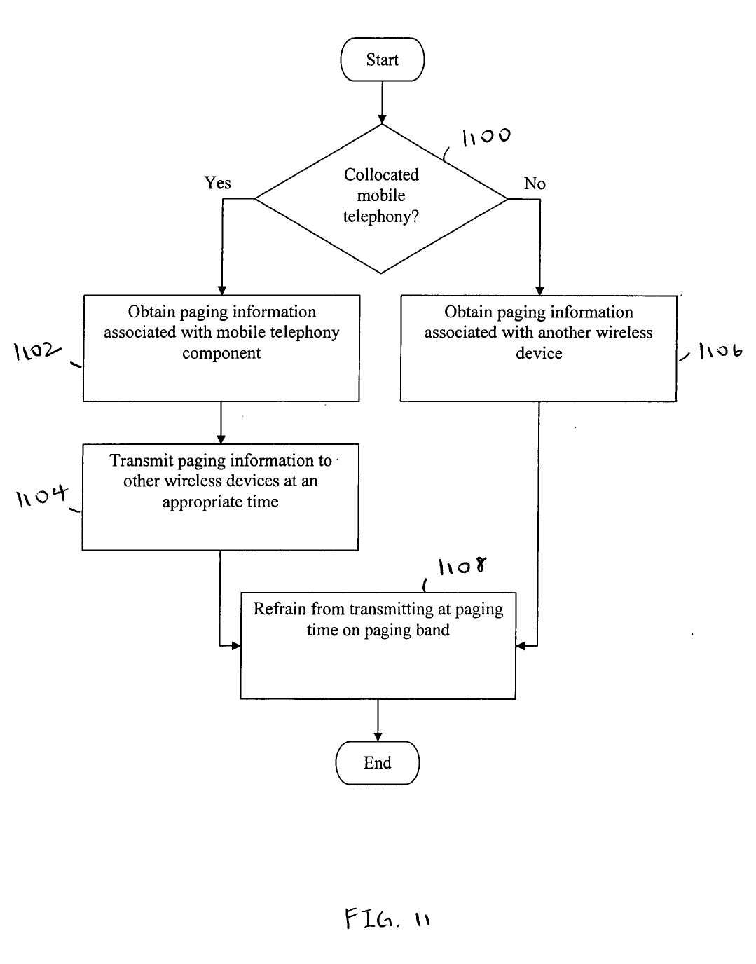

FIG. 10 is a flowchart illustrating an embodiment of a process for obtaining information specified by a regulatory agency. In the example shown, the process is performed by a UWB component that is portable, such as UWB component 804 of FIG. 8. In some embodiments, the process is initiated when a UWB component is powered on or otherwise started.

At 1000, position related information is obtained from available sources. Depending upon the particular mobile telephone, information from different sources is available. For example, some mobile telephones may have UWB capabilities but no GPS capabilities or vice versa. In some embodiments, a UWB component is configured to obtain position and/or time zone information from, for example, a collocated GPS component or a remote computer with a calendar or clock utility.

Weights are assigned to position related information at 1002. In some embodiments, information from one source is more reliable, detailed, timely, or otherwise useful than information from another source and the weights assigned reflect this. In one example, location information from a mobile telephone base station or GPS position information has the highest weight. Information from a fixed infrastructure network, such as from an IEEE 802.11 access point, is assigned a lower weight. Time zone information from a computer is assigned the lowest weight. A variety of rankings or weights can be used.

At 1004, a country or region is determined based on weighted position related information. In some embodiments, information with the highest weight is used to determine a country or region and the rest of the information is discarded. In some embodiments, the weighted information is combined to determine a country or region.

In some embodiments, a mobile telephone references a table it stores to determine a country or region. For example, a table may be organized based on latitude or longitude or may be organized based on time zones or time regions.

In some embodiments, a previous country or region is stored and used to determine the current country or region. For example, a mobile telephone typically stays in a single country or region. If no position and/or time zone information is available, the country or region is set to a saved country or region. In some embodiments, position and/or time information is available but is contradictory with respect to saved location information, or has a low priority. The previous country or region in some embodiments is used even if the obtained information indicates another region or country.

At 1006, a UWB transmit power mask information is obtained for a country or region. A variety of regulatory agencies around the world control transmission power levels in their particular region. For example, the European Union, Japan and the United State have different power restrictions on UWB transmissions. This may include a limitation on a transmit power level at a particular frequency spectrum. A Transmit Power Control (TPC) module within a UWB component may use a transmit power mask to set appropriate parameters.

A permitted set of UWB channels is obtained for a country or region at 1008. For example, some countries or regions may have specific restrictions on usable bands by UWB devices. Certain bands in certain countries are restricted because they are, for example, used by the military or are already licensed. A UWB component uses the permitted set of channels to select a wireless channel comprising of one or more bands. In some cases, a band permitted for UWB use in one country is not permitted to be used in another country.

In some embodiments, a mask obtained at 1006 and/or a set of permitted channels obtained at 1008 are retrieved from memory or storage associated with a UWB device. For example, once set by a regulatory agency, such information may not change frequently or at all.

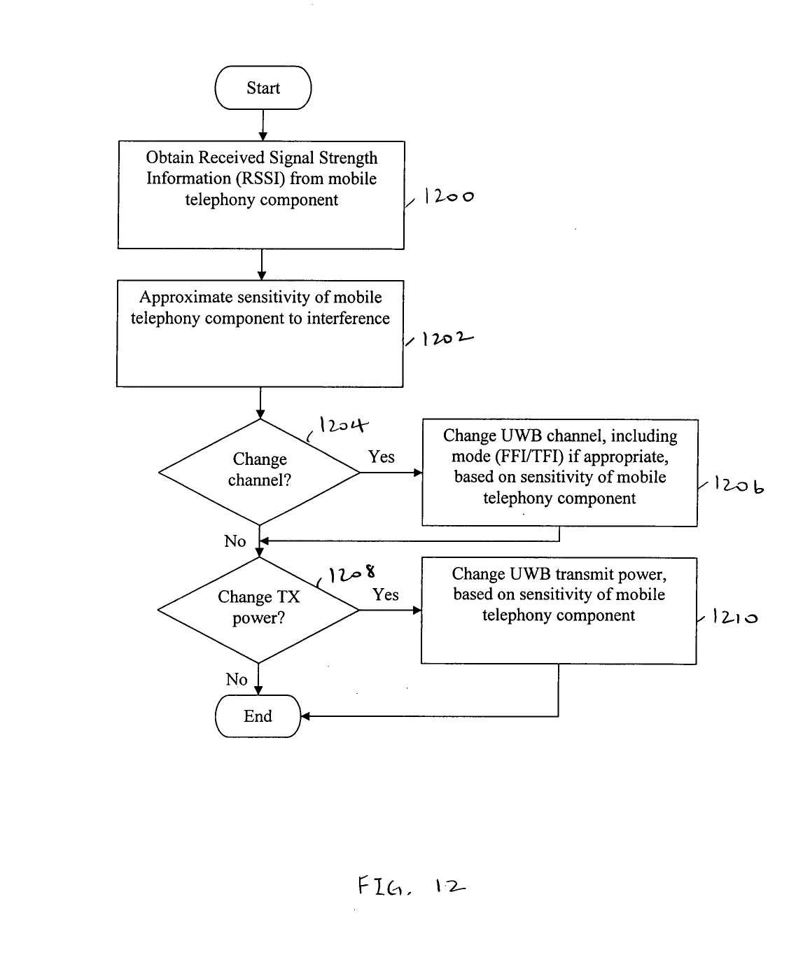

FIG. 11 is a flowchart illustrating an embodiment of a process for avoiding a paging time of a mobile telephone. The example process is performed by a CDMA system where a mobile telephone and a base station use pages to alert the mobile telephone there is an incoming call. At a paging time, the telephone and base station exchange a communication indicating whether or not there is an incoming call. The communication is exchanged on a particular frequency referred to as the paging band. A CMDA telephone often powers down some or all of a mobile telephony component to save power, and prior to the paging time the mobile telephony component is powered up. A paging time and/or paging band may depend upon which version of a telephony specification a particular mobile telephone is configured to support. For example, more recent versions of a specification allow a mobile telephone to sleep longer between paging times to further reduce power consumption. In some embodiments, other telephony protocols (e.g., GSM, PCS, etc.) are used and the process is modified accordingly.

It is decided at 1100 whether there is a collocated mobile telephony component. If there is, at 1102 paging information associated with a mobile telephony component is obtained. A variety of interfaces and/or signaling may be used to obtain this information from a collocated mobile telephony component. For example, an appropriate register may be read, or one or more signals between collocated components are used to exchange this information. Otherwise, if there is no collocated mobile telephony component, at 1106 paging information associated with another wireless device is obtained. In some embodiments, the other wireless device has a collocated UWB component, and the paging information is obtained via the UWB wireless channel.

At an appropriate time, paging information is transmitted to other wireless devices at 1104. It may be desirable for nearby wireless devices without a collocated mobile telephony component to avoid the paging time and paging band of the mobile telephone. In some embodiments, this information is included in a beacon frame, or may be included a dedicated frame associated with transmitting paging information.

If there is no collocated mobile telephony component, paging information is obtained from another wireless device at 1106. For example, information transmitted at 1104 by one device is received at 1106 by another device.

At 1108, a UWB device refrains from transmitting at a paging time on a paging band. By refraining from transmitting, a mobile telephone component is able to determine if there is an incoming call. In some embodiments, a UWB device refrains from transmitting for more than one paging time at 1108. The UWB device transmits between paging times when it will not interfere with detection of an incoming call.

In some embodiments, additional decision metrics are used. For example, a UWB device is able to transmit during a paging time on a paging band so long as the UWB device did not transmit during the prior paging time (i.e., a maximum number of consecutive transmissions by a UWB device during the paging time is permitted). In another example, a UWB device is able to transmit during a paging time based on priority. If UWB traffic is determined to have a priority above a threshold, the UWB device is permitted to transmit that traffic at the paging time on the paging band. In some embodiments, prior calling information is used in determining whether or not to refrain from transmitting at a paging time on a paging band. For example, if the current time corresponds to a time when the user typically receives calls (e.g., when school lets our and her children call), or the user receives calls very frequently (e.g., a user who is often on her mobile phone) the UWB device refrain from transmitting at 1108.

FIG. 12 is a flowchart illustrating an embodiment of a process for adjusting UWB properties based on RSSI information. In the example shown, a UWB component is collocated with a mobile telephony component. The mobile telephone component has a RSSI level or other received signal characteristic. In some mobile telephones such a received signal characteristic is displayed to the user as bars indicating signal strength in a cell phone.

RSSI or another signal characteristic/measurement is used in some embodiments to enable improved coexistence between a collocated mobile telephony component and a UWB component. For example, information about the received signal level at the mobile phone is known by the UWB device. This may indicate how sensitive a mobile phone is to interference.

At 1200, RSSI is obtained from a mobile telephony component. A variety of interfaces can be implemented to obtain this information. For example, signals between a collocated mobile telephony component and a UWB component may be used to obtain the information. Or, the information may be obtained by a driver or other software application associated with the UWB device that reads a register in the mobile telephony component.

At 1202, a sensitivity of a mobile telephony component to interference is approximated. For example, if the RSSI level is relatively high, the mobile telephone signal is robust in the presence of interference from the collocated UWB component. In some cases, an RSSI level is a coarse measurement, and the sensitivity level approximated at 1202 is similarly coarse. In some cases, a relatively small number of possible sensitivity levels are used.

It is decided at 1204 whether to change a UWB channel. In some embodiments, the decision is based on a sensitivity level approximated at 1202. For example, if the collocated mobile telephony component is relatively sensitive, a collocated UWB component may decide to use a channel that is non-interfering. If it is decided to change a channel, at 1206 a UWB channel is changed, including mode (FFI/TFI) if appropriate, based on the sensitivity of a mobile telephony component. For example, sensitivity information is used to decide whether to use a Fixed Frequency Interleaving (FFI) channel or a Time Frequency Interleaving (TFI) channel. In FFI mode, the channel is a single band, whereas in TFI mode the channel includes multiple bands that the UWB device alternates through. A UWB component may decide to operate in FFI mode when a collocated mobile telephony component is far away from a base station and operate in TFI mode when closer to a base station.

At 1208, it is determined whether to change transmit power. In some embodiments, the approximated sensitivity level is compared to a threshold. If it is decided to change the transmit power level, at 1210 the UWB transmit power is changed based on the sensitivity of a mobile telephony component. For example, if a mobile telephony component is relatively sensitive, the transmit power level of a collocated UWB component is tuned down to avoid interfering with the mobile telephony component. Conversely, if the mobile telephony component is not sensitive, the transmit power level of a UWB component can be maintained or increased.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for avoiding a protected wireless device, comprising:
receiving an indication that another wireless device has detected a protected wireless device; and
avoiding the protected wireless device in the event the wireless device that detected the protected wireless device is within a threshold number of hops from the wireless device that received the indication.

2. A method as recited in claim 1, wherein the protected wireless device includes a WiMAX wireless device.

3. A method as recited in claim 1, wherein the method is performed by an ultra wideband (UWB) wireless device.

4. A method as recited in claim 1, wherein the method is performed by an ultra wideband (UWB) wireless device, including a WiMedia UWB wireless device.

5. A method as recited in claim 1, wherein the indication is received in a beacon.

6. A method as recited in claim 1, wherein the indication is received in a beacon, the beacon includes a first information element in the event a transmitting wireless device detected a protected wireless device, and the beacon includes a second information element in the event the transmitting wireless device did not detect a protected wireless device.

7. A method as recited in claim 1, further comprising transmitting information associated with avoided band(s) and/or subcarrier(s) in the event the protected wireless device is avoided.

8. A method as recited in claim 1, further comprising transmitting information associated with avoided band(s) and/or subcarrier(s) in the event the protected wireless device is avoided, wherein the information is included in a beacon.

9. A method as recited in claim 1, further comprising transmitting information associated with avoided band(s) and/or subcarrier(s) in the event the protected wireless device is avoided, wherein the information is run length encoded.

10. A method as recited in claim 1, wherein avoiding includes passing information associated with band(s) and/or subcarrier(s) to be avoided from a media access controller (MAC) to a baseband processor.

11. A method as recited in claim 1, wherein avoiding includes passing information associated with band(s) and/or subcarrier(s) to be avoided from a media access controller (MAC) to a baseband processor, wherein the passed information is run length encoded.

12. A method as recited in claim 1, further comprising using avoidance information included in the received indication to process a received signal in the event the wireless device that detected the protected wireless device is greater than the threshold number of hops from the wireless device that received the indication.

13. A system for avoiding a protected wireless device, comprising:
a receiver configured to receive an indication that another wireless device has detected a protected wireless device; and
a transmitter configured to avoid the protected wireless device in the event the wireless device that detected the protected wireless device is within a threshold number of hops from the wireless device that received the indication.

14. A method for transmitting, comprising:
receiving, at a first wireless device, position related information from a second wireless device, wherein the first wireless device and the second wireless device are collocated;
obtaining, at the first wireless device, information specified by a regulatory agency based at least in part on the received position related information; and
transmitting in accordance with the information specified by the regulatory agency at the first wireless device.

15. A method as recited in claim 14, wherein obtaining includes retrieving from storage associated with the first wireless device.

16. A method as recited in claim 14, wherein the information specified by the regulatory agency includes a permitted transmission mask.

17. A method as recited in claim 14, wherein the information specified by the regulatory agency includes one or more permitted bands.

18. A method as recited in claim 14, wherein the position related information includes coordinates.

19. A method as recited in claim 14, wherein the position related information includes a country.

20. A method for transmitting, comprising:
receiving, at a wireless device, information associated with a mobile telephone from the mobile telephone, wherein the receiving wireless device and the mobile telephone are collocated; and
adjusting transmission at the wireless device based at least in part on the received information.

21. A method as recited in claim 20, wherein the received information includes information associated with paging time and adjusting includes suspending transmission during the paging time.

22. A method as recited in claim 20, wherein the received information includes information associated with received signal strength and adjusting includes reducing transmit power.

23. A method as recited in claim 20, wherein the received information includes information associated with received signal strength and adjusting includes avoiding frequency spectrum used by the collocated mobile telephone.
